(19) United States
(12) Patent Application Publication
(10) Pub. No.: US 2024/0399921 A1
(43) Pub. Date: Dec. 5, 2024

(54) POWER TRANSFER FROM VEHICLE-IN-MOTION TO POWER GRID

(71) Applicant: International Business Machines Corporation, Armonk, NY (US)

(72) Inventor: Sarbajit K. Rakshit, Kolkata (IN)

(21) Appl. No.: 18/329,013

(22) Filed: Jun. 5, 2023

(51) Int. Cl. B60L 55/00; H02J 13/00; H02J 50/10

(52) U.S. Cl. CPC B60L 55/00; H02J 13/00022; H02J 50/10

(57) ABSTRACT

A power transfer system is presented including a smart road having a first power line, a second power line, and a plurality of wireless smart road power receive components, a plurality of electric vehicles (EVs) traveling on the smart road, each of the EVs having a wireless EV power transfer component and a wireless EV power receive component, and a power grid electrically connected to the first and second power lines of the smart road to receive power from the plurality of EVs as the plurality of EVs travel on the smart road.

### BACKGROUND

The present invention relates generally to power transfer from a vehicle to a power grid, and more specifically, to transferring power from a traveling or running or operational or moving electric vehicle to the power grid via a smart road.

Vehicle-to-grid (V2G) technology refers to the process of feeding electricity included in an electric car's batteries back into the electrical grid while it is parked or stationary or motionless. This technology forms part of a smart grid, an electrical network system that uses information technology to manage energy consumption. Thanks to bi-directional charging, the V2G battery becomes an extension of the electrical grid by storing the energy produced while demand is lower and feeding it back into the system when demand is higher.

### SUMMARY

In accordance with an embodiment, a power transfer system is provided. The power transfer system includes a smart road having a first power line, a second power line, and a plurality of wireless smart road power receive components, a plurality of electric vehicles (EVs) traveling on the smart road, each of the EVs having a wireless EV power transfer component and a wireless EV power receive component, and a power grid electrically connected to the first and second power lines of the smart road to receive power from the plurality of EVs as the plurality of EVs travel on the smart road.

In accordance with another embodiment, a power transfer system is provided. The power transfer system includes a smart road having a plurality of wireless smart road power receive components, a plurality of electric vehicles (EVs) traveling on the smart road, each of the EVs capable of transferring battery power to the wireless smart road power receive components of the smart road, and a power grid electrically connected to the smart road such that clusters of EVs moving on the smart road voluntarily transfer battery power to the smart road so as to maintain proper isolation between the EVs to avoid induction interference.

In accordance with yet another embodiment, a method for transferring power is provided. The method includes incorporating a first power line, a second power line, and a plurality of wireless smart road power receive components into a smart road, allowing a plurality of electric vehicles (EVs) to travel on the smart road, each of the EVs having a wireless EV power transfer component and a wireless EV power receive component, and electrically connecting a power grid to the first and second power lines of the smart road to receive power from the plurality of EVs as the plurality of EVs travel on the smart road.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a block/flow diagram of an exemplary power transfer system for transferring power from a moving vehicle to the power grid, in accordance with an embodiment of the present invention;

FIG. 2 is a block/flow diagram of an exemplary diagram illustrating power requirements of a geo-fencing area shown on a map, in accordance with an embodiment of the present invention;

FIG. 3 is a block/flow diagram of an exemplary wireless power transfer module and a wireless power receive module attached to a vehicle and a wireless power receiving module affixed to the road which is electrically connected to the power grid, in accordance with an embodiment of the present invention;

FIG. 4 is a block/flow diagram of an exemplary dashboard depicting available battery power, travel patterns, and power required for remaining trips for a moving vehicle, in accordance with an embodiment of the present invention;

FIG. 5 is a block/flow diagram of an exemplary display of power required by the moving vehicles, power that can be transferred to the power grid by the moving vehicles, and a prompt to accept or reject power transfer by the drivers of the moving vehicles, in accordance with an embodiment of the present invention;

FIG. 6 is a block/flow diagram of an exemplary system where multiple roads are selected from which to get power based on the number of vehicles on such selected roads, in accordance with an embodiment of the present invention;

FIG. 7 is a block diagram of an exemplary display showing vehicles that participated in power transfer to the power grid and vehicles that received power from the grid during different days and times, in accordance with an embodiment of the present invention;

FIG. 8 is an exemplary map showing sub-regions created within the geo-fence to pinpoint power transfer activity, in accordance with an embodiment of the present invention;

FIG. 9 is an exemplary map showing different sizes and shapes of sub-regions created within the geo-fence, in accordance with an embodiment of the present invention;

FIG. 10 is an exemplary blockchain implementation of the power transfer system for transferring power from a moving vehicle to the power grid, in accordance with an embodiment of the present invention; and

FIG. 11 is a block diagram of an exemplary system where moving vehicles are clustered to extract data therefrom, in accordance with an embodiment of the present invention.

Throughout the drawings, same or similar reference numerals represent the same or similar elements.

### DETAILED DESCRIPTION

Embodiments in accordance with the present invention provide a vehicle-to-grid (V2G) system where vehicles in motion on smart roads have the capability to transfer power back to the power grid via the smart roads.

V2G is a technology that enables energy to be pushed back to the power grid from the battery of an electric car. With electric vehicle-to-grid technology, also known as car-to-grid, a car battery can be charged and discharged based on different signals, that is, based on energy production or consumption nearby.

V2X means vehicle-to-everything. V2X includes many different use cases such as vehicle-to-home (V2H), vehicle-to-building (V2B) and vehicle-to-grid services. Depending on whether a person wants to use electricity from an EV battery to a home or to building electrical loads, there are different abbreviations for each of these use cases.

The idea behind vehicle-to-grid is similar to regular smart charging. Smart charging, also known as V1G charging, enables the control of charging of electric cars in a way that allows the charging power to be increased and decreased when needed. V2G goes one step further and enables the charged power to also be momentarily pushed back to the grid from car batteries to balance variations in energy production and consumption. At any given time 95% of cars are parked or stationary or motionless, while their energy remains unused. V2G envisions sending some of the stored power to the grid (or reducing charge rates to pull less power from the grid). However, V2G currently works with parked or stationary vehicles located in pre-designated spots or areas.

The exemplary embodiments of the present invention take V2G a step further by providing power back to the power grid while the vehicles are operational or running or traveling or in-motion on smart roads. As a result, vehicles can participate in the V2G network and can transfer excess power as they are in motion or moving or traveling on the smart roads.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

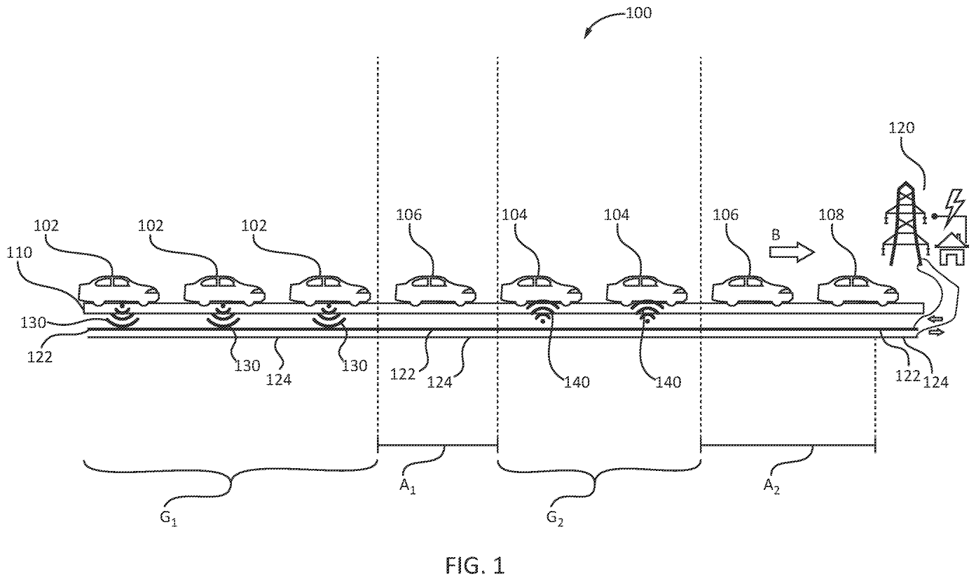

FIG. 1 is a block/flow diagram of an exemplary power transfer system for transferring power from a moving vehicle to the power grid, in accordance with an embodiment of the present invention.

The power transfer system 100 illustrates a plurality of vehicles traveling on a road or smart road 110. A first group of vehicles (G₁) can be designated as 102 and a second group of vehicles (G₂) can be designated as 104. The first group of vehicles 102 transfers power to the power grid 120. The second group of vehicles 104 receives power from the power grid 120. The transfer of power is designated as 130 and the reception of power is designated as 140. The power line 122 is used for transferring power to the vehicles 104 and a power line 124 is used for receiving power from the vehicles 102. The vehicles 106 and 108 do not need power and do not send power to the power grid 120.

An area A₁ includes vehicle 106 and an area A₂ includes another vehicle 106 and a vehicle 108. The vehicles 106, 108 in areas A₁ and A₂ provide for appropriate isolation so that interference in induction and wireless power transfer or power receive can be avoided. It is noted that the vehicles 102, 104, 106, 108 are in motion or are running or traveling on the smart road 110. The vehicles 102, 104, 106, 108 are not parked or stationary or motionless. The moving or traveling motion is designated by arrow “B.” The vehicles 102 are transferring power to the power grid 120 through the smart road 110 with induction wireless transfer. Basically, the vehicles 102 are selling power at a higher price as power consumption points need additional power. Therefore, the vehicles 102, 104 participate in power transfer with the power grid 120 while they are running or traveling or moving or are in motion on the smart road 110 (not parked or stationary or idle).

The smart road 110 is a smart road. A smart road is a road that incorporates electronic technologies. Smart roads are used to improve the operation of connected and autonomous vehicles, as well as traffic lights and street lighting. Smart roads use Internet of Things (IoT) devices to make driving safer, more efficient, and in line with government objectives, and greener. Smart roads combine physical infrastructures such as sensors and solar panels with software infrastructure like artificial intelligence (AI) and big data. Smart road technologies are embedded in roads and can improve visibility, generate energy, communicate with autonomous and connected vehicles, monitor road conditions, and more. Smart roads are specially engineered roadways fitted with smart features, including sensors that monitor and report changing road conditions, and WiFi transmitters that provide broadband services to vehicles, homes and businesses. The smart road can also charge electric cars as they drive thereon. The smart road can also receive power from electric vehicles.

An electric vehicle or EV is defined as a vehicle that can be powered by an electric motor that draws electricity from a battery and is capable of being charged from an external source. An EV includes both a vehicle that can only be powered by an electric motor that draws electricity from a battery (all-electric vehicle) and a vehicle that can be powered by an electric motor that draws electricity from a battery and by an internal combustion engine (plug-in hybrid electric vehicle).

An EV is a vehicle that uses one or more electric motors for propulsion. An EV can be powered by a collector system, with electricity from extravehicular sources, or it can be powered autonomously by a battery (sometimes charged by solar panels, or by converting fuel to electricity using fuel cells or a generator). EVs include, but are not limited to, road and rail vehicles, surface and underwater vessels, electrical aircraft, and electrical spacecraft. For road vehicles, together with other emerging automotive technologies such as autonomous driving, connected vehicles, and shared mobility, EVs form a future mobility vision called Connected, Autonomous, Shared, and Electric (CASE) Mobility.

Electric vehicles have low running costs as they have less moving parts for maintaining and are also environmentally friendly as EVs use little or no fossil fuels (petrol or diesel). While some EVs used lead acid or nickel metal hydride batteries, the standard for modern battery electric vehicles is now considered to be lithium ion batteries as they have a greater longevity and are excellent at retaining energy, with a self-discharge rate of just 5% per month.

The exemplary embodiments provide for a smart road that has a mechanism to wirelessly receive power directly from electric vehicles (EVs) which are running or traveling or operating on the smart road and transfer the same received power to the power grid. As a result, electric vehicles in motion on smart roads can also participate in power sharing by sending excess battery power back to the power grid (without having to park in a designated spot to initiate the process). The power transfer process from the electric vehicles to the power grid can be initiated or launched or commenced or triggered as the electric vehicle is moving or traveling or is in motion on the smart road (not parked or stationary or idle).

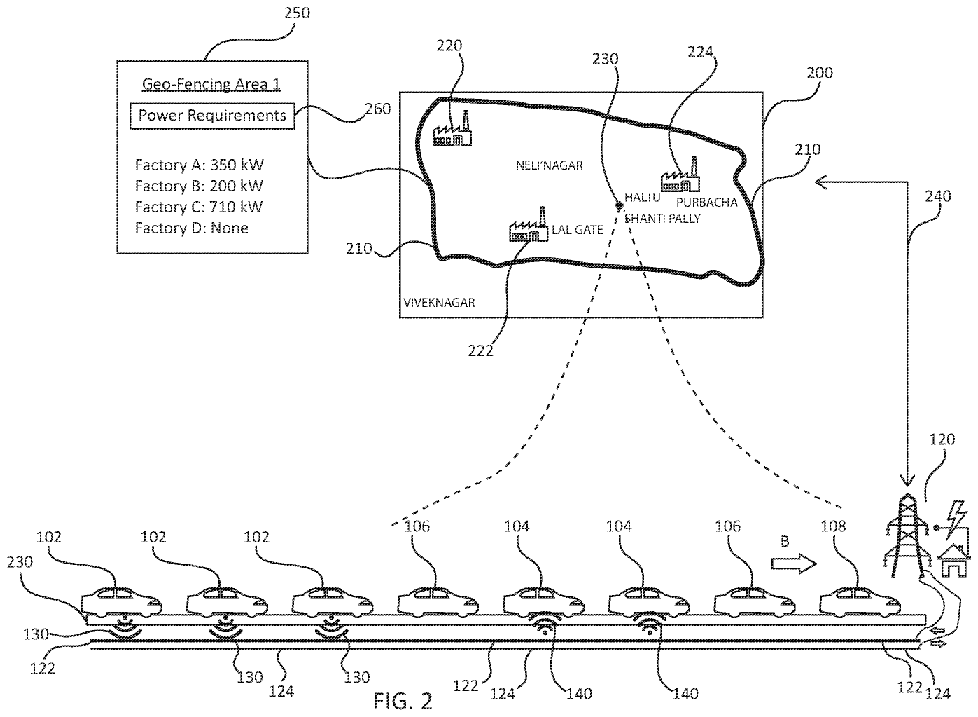

FIG. 2 is a block/flow diagram of an exemplary diagram illustrating power requirements of a geo-fencing area shown on a map, in accordance with an embodiment of the present invention.

Various power consumption points in a geographic location are shown on a map 200. The consumption points can be a first factory 220, a second factory 222, and a third factory 224. A boundary or geo-fencing area 210 is designated within the map 200. Within the geo-fencing area 210 a road 230 is selected from which power transfer can be achieved. The road 230 includes vehicles 102 which transfer power to the power grid 120. The power grid 120 then transfers power 240 to the first factory 220, the second factory 222, and the third factory 224. The power requirements 260 can be displayed in a geo-fencing area 250. For example, the first factory 220 can have a power requirement of 350 kilowatts, the second factory 222 can have a power requirement of 200 kilowatts, and the third factory 224 can have a power requirement of 710 kilowatts. The remaining factories may have no power requirements. The geo-fencing area 210 is defined by what factories or what consumption points need additional power.

The geo-fencing area or geo-fence 210 is a virtual perimeter for a real-world geographic area. The geo-fence 210 is dynamically generated based on the location of the consumption points requesting power from the power grid. The geo-fence 210 can have a symmetrical or asymmetrical shape. The geo-fence 210 can have an irregular or unconventional shape that is manipulated to accommodate all the consumption points, as well as to incorporate busy smart roads with loads of vehicle traffic.

In this scenario, when the factories 220, 222, 224 need additional power from the power grid 120, the power grid 120 can select the road 230 within the geo-fencing area 210 of the map 200 to find vehicles that have the capability of transferring power to the power grid 120 which in turn can transfer the power back to the factories 220, 222, 224. Therefore, vehicles in motion, such as vehicles 102, can transfer power back to the power grid 120 while they are traveling or running on the road 230.

A road on a map including consumption points can be selected by, e.g., historical travel patterns on such roads during different days and times. In one instance, if it is 8:00 AM in the morning, then main roads that connect towns or cities can be selected based on the heavy traffic on such roads at that time. A high volume of vehicles indicates a greater or higher probability that such vehicles have capacity or capability to transfer power back to the power grid 120. In another instance, the selection of the road on the map 200 can be based on cameras positioned within streets and roads of the map 200. The cameras can feed live streams of traffic data to a central system that collects data regarding vehicles on the roads. The central system can automatically provide recommendations or suggestions for which roads to select based on the volume of traffic. In yet another instance, the drivers of the vehicles themselves can designate whether they are willing to transfer power to the power grid 120. Each of the vehicles may be equipped with a mechanism to indicate that they are willing to connect to the power line 122 to enable power transfer.

If the power grid 120 needs additional power from moving vehicles 102, then the power grid 120 can publish or transmit power requirement notifications to appropriate geo-fencing areas, and accordingly the vehicles 102 running or traveling or moving on the smart road inside the geo-fencing area 210 can respond to the notification and participate in transferring excess power through the smart road 110 to the power grid 120.

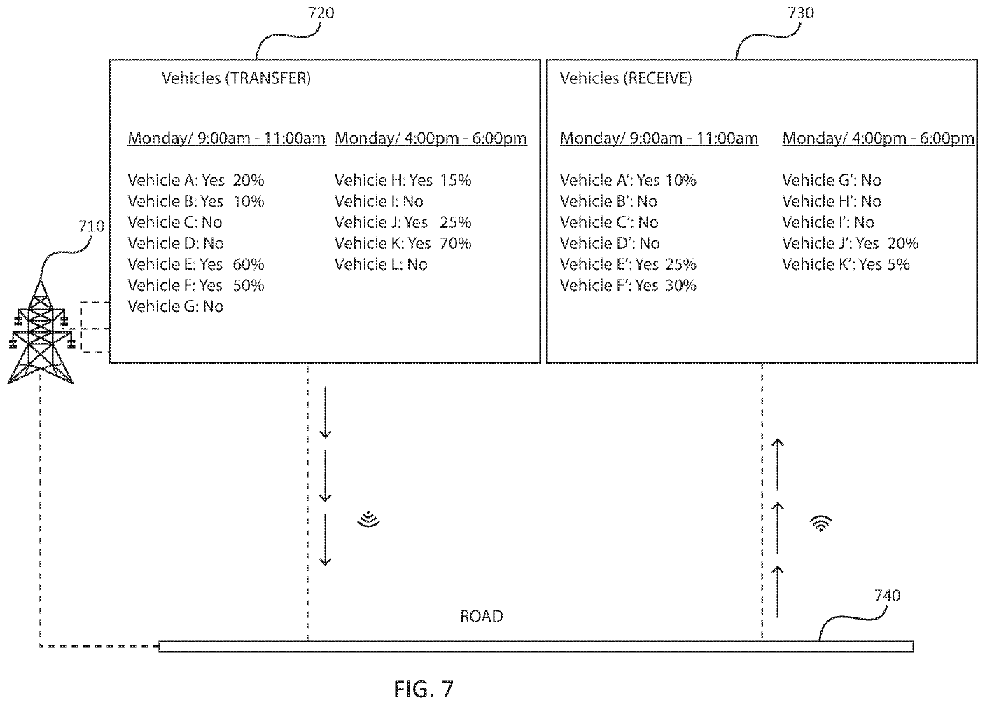

At certain times, a set of running or moving vehicles 104 can receive power from the smart road 110 and a set of the vehicles 102 can transfer power to the smart road 110. In such case, the exemplary embodiments identify which vehicles are receiving power from the smart road 110 and which vehicles are transferring power to the smart road 110, and create appropriate spacing among those vehicles (receiving vs transferring vs neutral), so that there is no interference in the induction of wireless power transfer, as will be described in further detail below with reference to FIG. 7.

The exemplary power grid 120 evaluates or monitors how much power is transferred to the vehicles from the smart road 110, and how much power is received from the vehicles, and accordingly identify if geo-fencing boundary ranges need to be altered or adjusted or fine-tuned to send the notification to the vehicles, so that the power grid 120 can receive the required power, as will be described in further detail below with reference to FIG. 9.

While the vehicles 102, 104, 106, 108 are traveling on the smart road 110, the exemplary system can also identify the available power of each vehicle, the distance that can be traveled by the vehicle with the current battery power, historical usage patterns, etc., and accordingly the vehicles can identify how much power can be transferred to the power grid through the smart road 110 during a moving or traveling or in-motion condition.

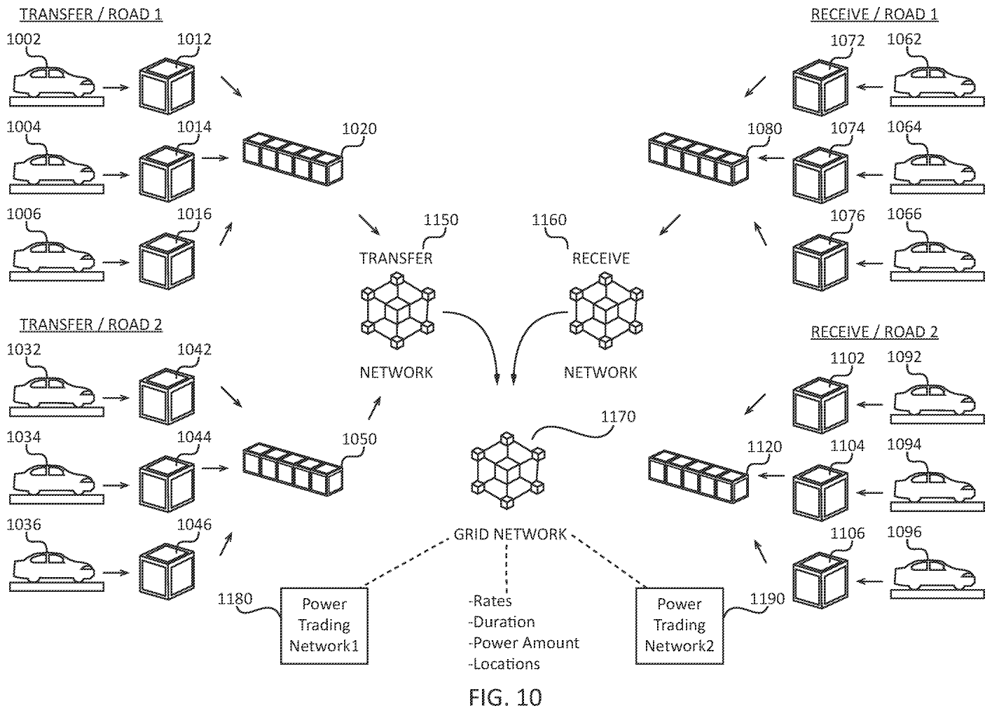

It is noted that vehicles can transfer power to the power grid 120 through the smart road 110 with different rates while receiving power, and accordingly a blockchain can be employed to capture the rate, duration and amount of power transfer, location of power transfer etc., and accordingly the vehicles can participate in power trading through the smart road, as will be described in further detail below with reference to FIG. 10.

FIG. 2 further pertains to vehicles transferring power to the power grid through the smart road, and vehicles are arranged properly on the smart road so that induction power interference between power transfer to vehicle and power transfer to smart road can be avoided. The vehicles are thus arranged accordingly, and the exemplary system publishes or transmits the notification around a geo-fencing area in any geographic surrounding.

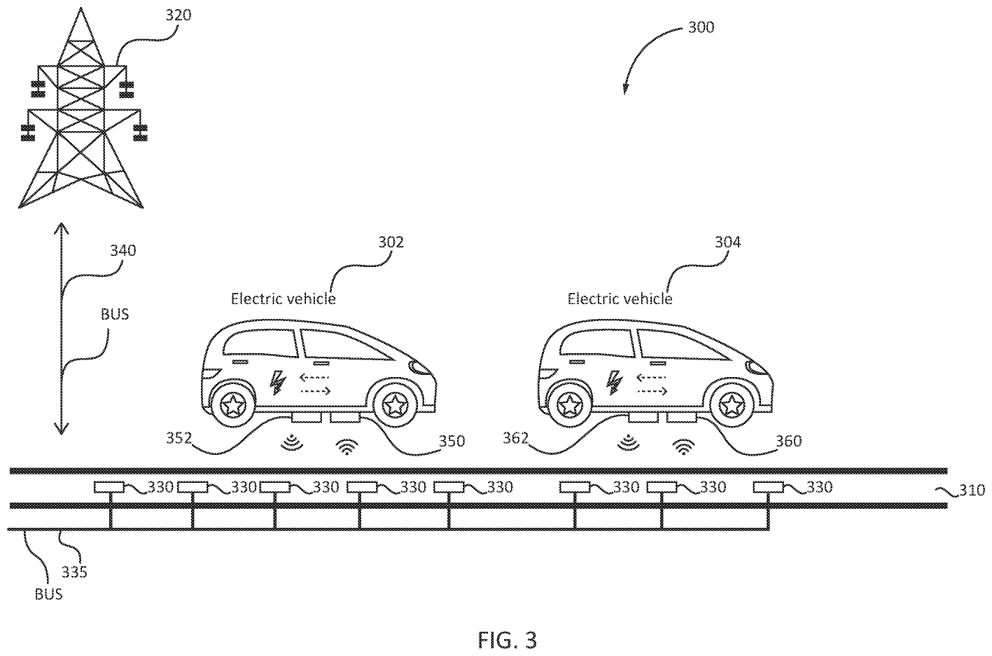

FIG. 3 is a block/flow diagram of an exemplary wireless power transfer module and a wireless power receive module attached to a vehicle and a wireless power receiving module affixed to the road which is electrically connected to the power grid, in accordance with an embodiment of the present invention.

The system 300 shows two electric vehicles 302, 304. The first electric vehicle 302 includes a wireless power transfer component 350 and a wireless power receive component 352. The second electric vehicle 304 also includes a wireless power transfer component 360 and a wireless power receive component 362. The wireless power transfer component 350 and the wireless power receive component 352 of the first electric vehicle 302 can be affixed or attached to the vehicle chassis. Of course, one skilled in the art can contemplate positioning the wireless power transfer component 350 and the wireless power receive component 352 anywhere within or outside the electric vehicle 302.

The wireless power transfer component 350 and the wireless power receive component 352 of the first electric vehicle 302 can electrically communicate with a wireless power receive component 330 that is associated with the smart road 310. The smart road 310 includes a plurality of wireless power receive components 330. In one example, the wireless power receive components 330 can be equally spaced apart with respect to each other. In an embodiment, the wireless power receive components 330 can be integrated or embedded within the smart road 310. Of course, one skilled in the art can contemplate attaching or affixing or incorporating the wireless power receive components 330 in any suitable manner to the smart road 310.

The wireless power receive components 330 can all be connected to a bus 335, which can transfer power 340 to the power grid 320. Therefore, vehicles in motion, such as electric vehicles 302, 304 can transfer power back to the power grid 320 while they are traveling or running on the smart road 310. In one example, the smart road 310 can include therein or thereon wireless power receive components 330 that have the capability of receiving and storing power from the electric vehicles 302, 304. The received power from the electric vehicles 302, 304 can be transferred, via the bus 335, back to the power grid 320. The power grid 320 can then transfer such power to any consumption points by designating a geo-fencing area around the consumption points that requested power from the power grid 320.

With new pressures for cities to develop more effective roadways and highways, smart infrastructure is essential for modernization. Smart roads built on IoT and information and communications technology (ICT) can make it possible for cities and transportation authorities to collect and analyze data to improve day-to-day traffic management. Smart road infrastructure can also help cities adapt for long-term sustainable transportation needs. With IoT sensors, cameras, radar, and 5G-equipped technologies, data can be analyzed in near-real time and used to improve congested roadways, streamlining traffic flow. Data can also be sent to the cloud for long-term analysis, as well as to power grids to control power transfer between vehicles in motion on smart roads and the power grid.

There are many types of devices that enable smart road technology, that is, speed sensors, acoustic sensors, IP CCTV cameras, smart traffic lights, condition and weather monitoring systems, and digital signage. When these devices collect and analyze data in near-real time, cities can realize several benefits including efficient power transfer between vehicles in motion on smart roads and the power grid. Such smart road technology can further include the wireless power receive components 330 that have the capability of receiving and storing power from the electric vehicles 302, 304. Smart roads are a component of the smart cities concept, which applies advanced information technologies, such as Internet-of-Things (IoT), cloud computing, big data, and artificial intelligence, to facilitate the planning, construction, management, and services of smart cities, as well as power efficiency requirements. The exemplary embodiments of the present invention are designed to enable smart cities to efficiently transfer power between, e.g., electric vehicles and the power grid via smart roads.

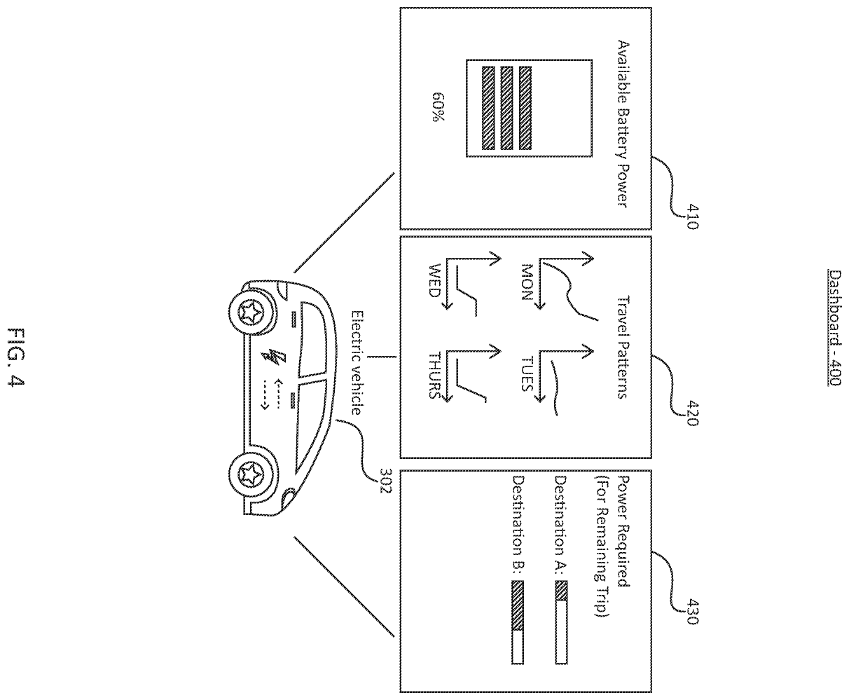

FIG. 4 is a block/flow diagram of an exemplary dashboard depicting available battery power, travel patterns, and power required for remaining trips for a moving vehicle, in accordance with an embodiment of the present invention.

The electric vehicle 302 can have a dashboard 400 that displays various data to the driver of the electric vehicle 302. The dashboard 400 can display an available battery power window 410, a travel patterns window 420, and a power required window 430. The available battery power window 410 indicates to the driver that the battery power is at 60%. The travel patterns window 420 indicates where the driver has driven, for example, during a specified week. The power required window 430 indicates to the driver how much power remains to reach destination A and how much power remains to reach destination B, based on the driver's historical travel patterns. As a result, while the electric vehicle 302 is traveling on the road, the electric vehicle 302 is constantly and continuously estimating the available battery power of the electric vehicle 302. This constant estimation of available battery power allows the driver to determine how much power can be transferred to the smart road, and, thus, back to the power grid.

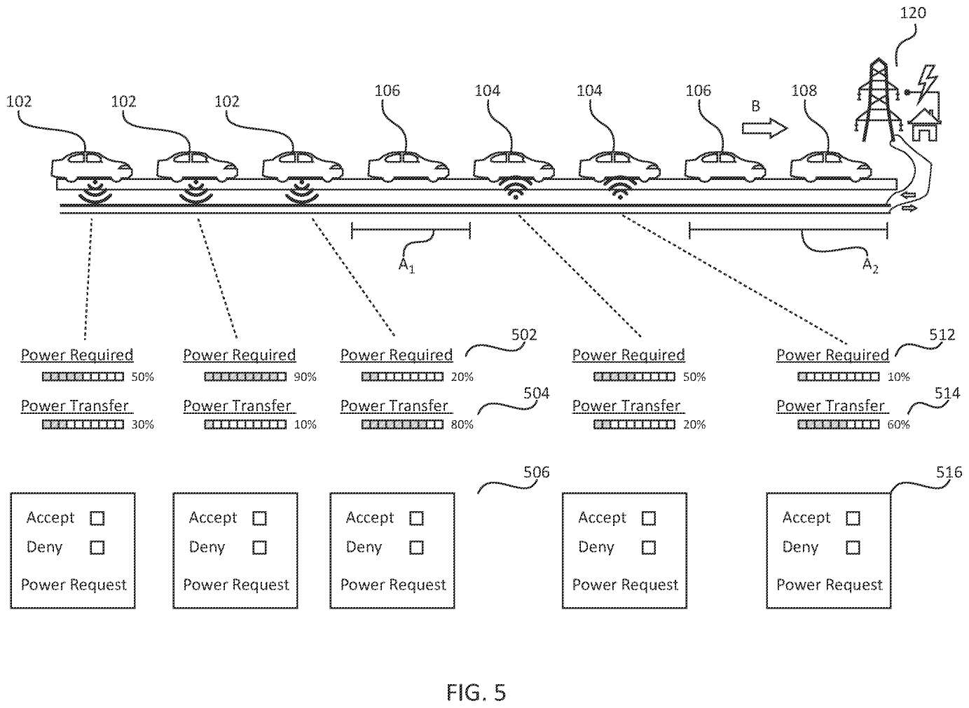

FIG. 5 is a block/flow diagram of an exemplary display of power required by the moving vehicles, power that can be transferred to the power grid by the moving vehicles, and a prompt to accept or reject power transfer by the drivers of the moving vehicles, in accordance with an embodiment of the present invention.

In one example, the group of vehicles 102 can each have a dashboard displaying power required, power transferred, and power requests. The dashboard can provide notifications to the driver. The first vehicle of the group of vehicles 102 can have a power required of 50% and a power transfer of 30%. The second vehicle of the group of vehicles 102 can have a power required of 90% and a power transfer of 10%. The third vehicle of the group of vehicles 102 can have a power required of 20% and a power transfer of 80%. The power required of the first group of vehicles 102 can be designated as 502 and the power transfer of the first group of vehicles 102 can be designated as 504. The power request can be designated as 506. The power request allows the driver of the vehicle to determine whether to accept or deny a power request from the power grid 120. Therefore, the drivers of the first group of vehicles 102 are not required or mandated or obligated to transfer power to the power grid 120. Instead, the drivers of the first group of vehicles 102 have the option to either opt in or opt out from a request to transfer power to the power grid 120. A driver may not wish to transfer power to the power grid 120 because the driver is anticipating, e.g., making a long distance trip that requires all that power.

Similarly, the group of vehicles 104 can each have a dashboard displaying power required, power transferred, and power requests. The first vehicle of the group of vehicles 104 can have a power required of 50% and a power transfer of 20%. The second vehicle of the group of vehicles 104 can have a power required of 10% and a power transfer of 60%. The power required of the second group of vehicles 104 can be designated as 512 and the power transfer of the second group of vehicles 104 can be designated as 514. The power request can be designated as 516. These vehicles are receiving power from the power grid 120.

As a result, the vehicle can also estimate and notify the driver regarding the amount of power that can be transferred to the power grid 120 through the smart road. As noted, the drivers of the vehicles have the option of participating or not participating with the power transfer request.

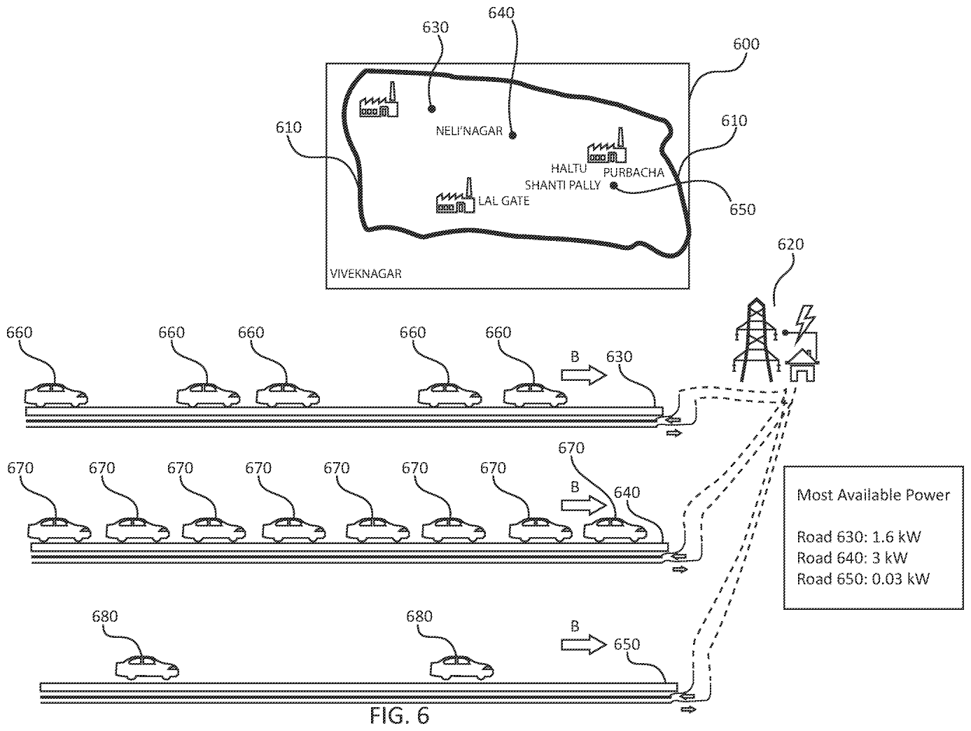

FIG. 6 is a block/flow diagram of an exemplary system where multiple roads are selected from which to get power based on the number of vehicles on such selected roads, in accordance with an embodiment of the present invention.

The power grid 620 can select any road of a plurality of roads on a map 600. For example, the map 600 depicts consumption points that need further power. The consumption points are shown within a geo-fence 610. In other words, the geo-fence 610 has been drawn to encompass all the consumption points that need further power. Within the geo-fence 610, in one example, three roads have been selected that can provide adequate power to the consumption points within the geo-fence 610. A first road 630, a second road 640, and a third road 650 have been designated as potential candidates from which to draw more power therefrom. The roads 630, 640, 650 have been selected based on the volume of traffic on such smart roads, as well as their proximity to the consumption points.

For instance, the road 630 includes a plurality of cars 660 that have the capability to transfer power to the road 630. The road 640 includes a plurality of cars 670 that have the capability to transfer power to the road 640. The road 650 includes a plurality of cars 680 that have the capability to transfer power to the road 650. The road 630 can provide 1.6 kilowatts of power, the road 640 can provide 3 kilowatts of power, and the road 650 can provide 0.03 kilowatts of power. Therefore, the power grid 620 can match the power requirements of the consumption points with various power availability of roads.

If a first consumption point needs 10 kilowatts of additional power, the power grid 620 can select a road that can provide the 10 kilowatts of additional power. If a second consumption point needs 20 kilowatts of additional power, the power grid 620 can select a road that can provide the 20 kilowatts of additional power. If a third consumption point needs 100 kilowatts of additional power, the power grid 620 can select two or more roads that can provide the 100 kilowatts of additional power. Therefore, power transfer matching can take place based on supply and demand. If there is a demand for 300 kilowatts of additional power, the power grid 620 can seek out roads within the geo-fence 610 that can match such power requirements. Additionally, a table can be presented with a list of all the roads sorted with the road that has the most available power.

The power grid 620 has the capability to count the number of vehicles on each of the smart roads 630, 640, 650. The power grid 620 can have a list or table of vehicles on each of the smart roads 630, 640, 650 with the battery power of each vehicle. The power grid 620 can also request specific power requirements form each vehicle on each road. For example, the power grid 620 can determine that the road 640 has 15 electric vehicles thereon, and that a first vehicle has 70% battery power, a second vehicle has 75% battery power, a third vehicles has 90% battery power, a fourth vehicles has 65% battery power, etc., and the power grid 620 can send a first notification to the first vehicle requesting 25% battery power (knowing battery power is at 70%), can send a second notification to the second vehicle requesting 30% battery power (knowing battery power is at 75%), and can send a third notification to the third vehicle requesting 50% battery power (knowing battery power is at 90% and knowing that the driver has almost reached his destination). As a result, the power grid 620 can send targeted notifications to individual vehicles based on the determined battery power of each vehicle and the determined final destination of each vehicle.

The power grid 620 can also send targeted notifications to vehicles based on a driver's past willingness or inclination to transfer power. Stated different, based on a driver's past power transfer activity. For example, based on historical data, the power grid 620 knows that vehicle A allows or permits or opts-in to transfer battery power 80% of the time the vehicle is traveling on smart roads close to certain consumption points. Further regarding vehicle B, the power grid 620 knows that such vehicle allows or permits or opts-in to transfer battery power 10% of the time while traveling on smart roads. The power grid 620 can then selectively send notifications to vehicles that have a high probability of accepting the power transfer request. As a result, the power grid 620 does not waste time sending notifications to vehicles that are not inclined to participate in the power transfer process. Additionally, the drivers of such vehicles do not become annoyed with the power transfer notifications, as such requests may only be sent sporadically or periodically to such drivers based on extremely high demand from consumption points.

The power grid 620 can also send targeted notifications to vehicles based on a driver's past disclosure or declaration for financial incentives. For example, drivers wanting to transfer battery power back to the power grid 620 can notify the power grid 620 that they want to do so to make extra money. Driver A of vehicle A may want to make an extra $500 this month. As such, such driver can send a notification to the power grid 620 to inform the power grid 620 that he/she wants to make an extra $500 this month. As such, the power grid 620 may prioritize such driver when sending notifications. When the financial threshold is met, the power grid 620 may ignore such driver until the next month and provide other drivers with such financial incentives. Therefore, individual drivers can provide the power grid 620 with specific requests for how much money they would like to make by transferring battery power back into the smart roads.

FIG. 7 is a block diagram of an exemplary display showing vehicles that participated in power transfer to the power grid and vehicles that received power from the grid during different days and times, in accordance with an embodiment of the present invention.

The exemplary system can identify which vehicles have participated in power transfer to the power grid through the smart road and can further identify which vehicles are receiving power from the smart road while in motion or traveling on the smart road. For example, a power transfer table 720 is presented. The power transfer table 720 details which vehicles transferred power to the smart road 740 on specific dates and specific times.

On Monday morning, vehicle A transferred 20% of its battery power to the power grid 710, vehicle B transferred 10% of its battery power to the power grid 710, vehicles C and D did not transfer any battery power to the power grid 710, vehicle E transferred 60% of its battery power to the power grid 710, vehicle F transferred 50% of its battery power to the power grid 710, and vehicle G did not transfer any power to the power grid 710.

On Monday evening, vehicle A transferred 15% of its battery power to the power grid 710, vehicle I did not transfer any battery power the power grid 710, vehicle J transferred 25% of its battery power to the power grid 710, vehicle K transferred 70% of its battery power to the power grid 710, and vehicle L did not transfer any power to the power grid 710.

As a result, the power transfer table 720 can identify vehicles that have participated in power transfer to the power grid 710 through the smart road 740. The power transfer table 720 can break down the data by day and by time and by power transfer percentage for each and every vehicle that was in motion on any smart road within a geo-fence of a map.

Regarding vehicles that receive power from the smart road 740, the power received table 730 is presented. The power receive table 730 details which vehicles received power from the smart road 740 on specific dates and specific times.

On Monday morning, vehicle A′ received 10% of its battery power from the power grid 710, vehicle B′, C′ and D′ received no power from the smart road 740, vehicle E′ received 25% of its battery power from the power grid 710, and vehicle F′ received 30% of its battery power from the power grid 710.

On Monday evening, vehicles G′, H′ and I′ received no power from the smart road 740, vehicle J′ received 20% of its battery power from the power grid 710, and vehicle K′ received 5% of its battery power to the power grid 710.

As a result, the power receive table 730 can identify vehicles that have participated in power transfer from the power grid 710 through the smart road 740. The power receive table 730 can break down the data by day and by time and by power receive percentage for each and every vehicle that was in motion on any smart road within a geo-fence of a map.

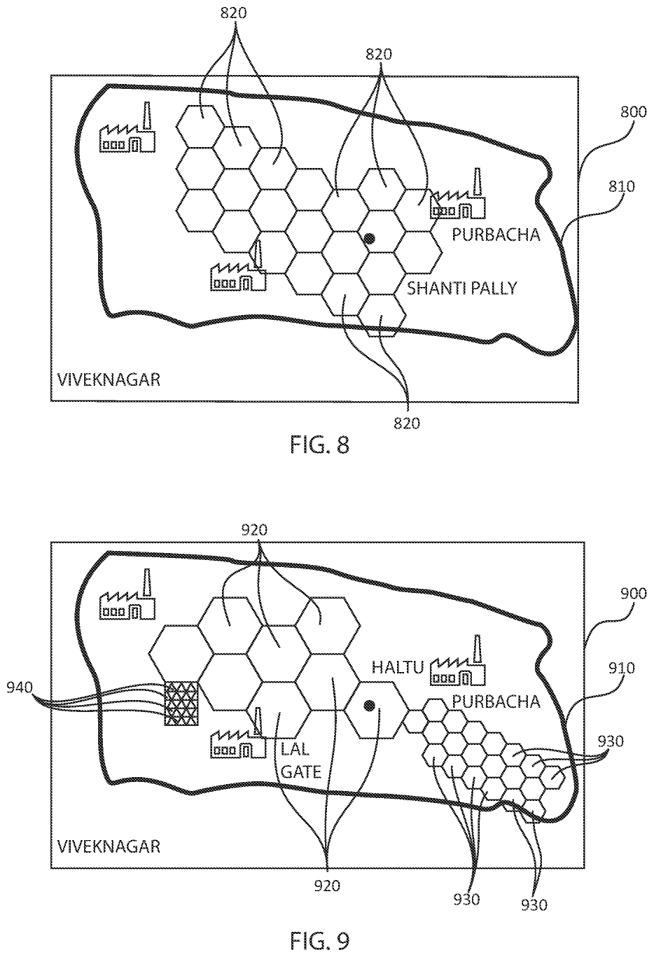

FIG. 8 is an exemplary map showing sub-regions created within the geo-fence to pinpoint power transfer activity, in accordance with an embodiment of the present invention.

The map 800 depicts a plurality of consumption points. A geo-fence 810 has been drawn around the consumption points. A plurality of sub-regions 820 can be created within the geo-fence 810 to pinpoint transfer activity. The plurality of sub-regions 820 can be constructed from a plurality of different shapes. In the instant example, the plurality of sub-regions 820 have a substantially hexagonal shape. Each sub-region 820 includes a plurality of smart roads. Total power transfer availability can be determined within each sub-region 820. In other words, a first sub-region 820 can have 300 kilowatts of power transfer availability based on the volume of traffic within that sub-region 820. A second sub-region 820 can have 500 kilowatts of power transfer availability based on the volume of traffic within that sub-region 820. A third sub-region 820 can have 1000 kilowatts of power transfer availability based on the volume of traffic within that sub-region 820. Therefore, based on how much additional power a consumption point needs, the power grid can zero in or pinpoint a specific sub-region 820. Stated differently, the geo-fence 810 can be broken down into or subdivided into a plurality of equally sized sub-regions 820. Each equally sized sub-region 820 includes a plurality of smart roads. Each smart road within each sub-region 820 can provide different amounts of power back to the grid based on the volume of traffic within each sub-region 820. Thus, specific sub regions 820 within the geo-fence 810 can be strategically selected which include high volumes of traffic from high volumes of vehicles, which potentially have high battery transfer capabilities. Therefore, the selection process is not a random process. Instead, the selection process is a very smart and strategic process, where the power grid can pinpoint or target areas or regions or segments within the geo-fence 810 of the map 800 to quickly and efficiently find or discover or recognize or reveal the best available power transfer locations.

FIG. 9 is an exemplary map showing different sizes and shapes of sub-regions created within the geo-fence, in accordance with an embodiment of the present invention.

The map 900 depicts a geo-fence 910 encompassing a plurality of consumption points that need power. A plurality of sub-regions 920, 930, 940 can be created within the geo-fence 910 to pinpoint transfer activity. The plurality of sub-regions 920, 930, 940 can be constructed from a plurality of different shapes. In the instant example, the plurality of sub-regions 920 have a substantially hexagonal shape of a first size and the plurality of sub-regions 930 have a substantially hexagonal shape of a second size. The plurality of sub-regions 940 have a substantially triangular shape, where multiple abutting triangles are displayed. The sub-regions 940 can represent, e.g., a downtown area with high traffic congestion. This high congestion area can be used to the power grid's advantage because such congestion area includes hundreds, if not thousands of vehicles that could potentially transfer power back to the power grid via the smart roads they are traveling on.

As a result, one or more geo-fences within a map can include a plurality of sub-regions or subareas or segments where high volume of traffic is detected at different periods of the day. The system can take advantage of such high traffic volume areas by focusing or concentrating on such areas to extract the maximum amount of available power, via the smart roads, back to the power grid.

The sub-regions of FIGS. 8 and 9 can be selected based on artificial intelligence (AI) methods. AI can be used to optimize the power grid and to optimize power transfer between smart roads and electric vehicles. AI can help better match energy needed by energy consumption points and energy provided by electric vehicles to smart roads. A customized or specialized AI engine or AI component can be used to efficiently manage and distribute power between vehicles and/or to efficiently manage and distribute power from vehicles to the smart road to the power grid, and then to the consumption points. The AI machine can use neural networks (artificial neural networks) or deep learning techniques.

Artificial neural networks (ANNs) include node layers, containing an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network. Neural networks rely on training data to learn and improve their accuracy over time. However, once these learning algorithms are fine-tuned for accuracy, they are powerful tools, allowing users to classify and cluster data at a high velocity. In the instant case, a power transfer AI machine can employ a power transfer neural network having multiple specialized power transfer hidden layers configured to optimize power transfer within the power transfer systems of the exemplary embodiments of the present invention.

Additionally, the AI power transfer machine can aid in altering or adjusting or manipulating the boundaries or perimeters of the geo-fence to optimize power transfer capabilities by automatically selecting sub-regions within the geo-fence that can meet the power demands of the various consumption points.

FIG. 10 is an exemplary blockchain implementation of the power transfer system for transferring power from a moving vehicle to the power grid, in accordance with an embodiment of the present invention.

The exemplary embodiments of the present invention can be implemented in a blockchain configuration. A blockchain is a distributed database or ledger shared among a computer network's nodes. Blockchains are best known for their role in cryptocurrency systems for maintaining a secure and decentralized record of transactions, but they are not limited to cryptocurrency uses. Blockchains can be used to make data in any industry immutable, that is, an inability to be altered or modified.

Stated differently, a blockchain is a shared, immutable ledger that facilitates the process of recording transactions and tracking assets in a business network. An asset can be tangible (a house, car, cash, land) or intangible (intellectual property, patents, copyrights, branding). Virtually anything of value can be tracked and traded on a blockchain network, reducing risk and cutting costs for all involved. Blockchains are important because business runs on information. The faster it's received and the more accurate it is, the better. A blockchain is ideal for delivering that information because a blockchain provides immediate, shared and completely transparent information stored on an immutable ledger that can be accessed only by permissioned network members. A blockchain network can track orders, payments, accounts, production and much more. Since members share a single view of the truth, a person can see all details of a transaction end to end, giving the person greater confidence, as well as new efficiencies and opportunities.

In a blockchain, as each transaction occurs, it is recorded as a “block” of data. Those transactions show the movement of an asset that can be tangible (a product) or intangible (intellectual). The data block can record the information: who, what, when, where, how much and even the condition, such as power transfer data between vehicles and a power grid. Each block is connected to the ones before and after it. These blocks form a chain of data as an asset moves from place to place or ownership changes hands. The blocks confirm the exact time and sequence of transactions, and the blocks link securely together to prevent any block from being altered or a block being inserted between two existing blocks. Transactions are blocked together in an irreversible chain, that is, a blockchain. Each additional block strengthens the verification of the previous block and hence the entire blockchain. This renders the blockchain tamper-evident, delivering the key strength of immutability. This removes the possibility of tampering by a malicious actor and builds a ledger of transactions you and other network members can trust.

Referring back to FIG. 10, the power transfer system can be implemented by a blockchain configuration. For example, regarding transferring power from a first road, a vehicle 1002 can be represented as a block 1012, a vehicle 1004 can be represented as a block 1014, and a vehicle 1006 can be represented as a block 1016. The blocks 1012, 1014, 1016 can be represented as a data block 1020. Similarly, regarding transferring power from a second road, a vehicle 1032 can be represented as a block 1042, a vehicle 1034 can be represented as a block 1044, and a vehicle 1036 can be represented as a block 1046. The blocks 1042, 1044, 1046 can be represented as a data block 1050.

For example, regarding receiving power from a first road, a vehicle 1062 can be represented as a block 1072, a vehicle 1064 can be represented as a block 1074, and a vehicle 1066 can be represented as a block 1076. The blocks 1072, 1074, 1076 can be represented as a data block 1080. Similarly, regarding receiving power from a second road, a vehicle 1092 can be represented as a block 1102, a vehicle 1094 can be represented as a block 1104, and a vehicle 1096 can be represented as a block 1106. The blocks 1102, 1104, 1106 can be represented as a data block 1120.

The data block 1020 and the data block 1050 can be combined and represented as a first transfer network 1150. The data block 1080 and the data block 1120 can be combined and represented as a second transfer network 1160. The first transfer network 1150 can be combined with the second transfer network 1160 to create a grid network 1170. The grid network 1170 can capture details regarding rates of power, amount of power transfer, location of power transfer, etc. The grid network 1170 enables power transfer between vehicles. The grid network 1170 can also enable power transfer from vehicles to any other structures within the vicinity of the vehicles. In one example, the first power trading network 1180 and a second power trading network 1190 can be provided. The first power trading network 1180 permits or allows power transfer between a vehicle A and a vehicle B traveling on a same road. The first power trading network 1180 enables power transfer between a plurality of vehicles traveling on the same road or on adjacent roads or on nearby roads within, e.g., a sub-region, as described above with regards to FIGS. 8 and 9.

The power transfer blockchain of FIG. 10 can be a public blockchain, that is, one that anyone can join and participate in. In another example, the power transfer blockchain of FIG. 10 can be a private blockchain, such as a decentralized peer-to-peer network. One or more organizations govern the power grid network, controlling who is allowed to participate, execute a consensus protocol and maintain the shared ledger. This can significantly boost trust and confidence between participants.

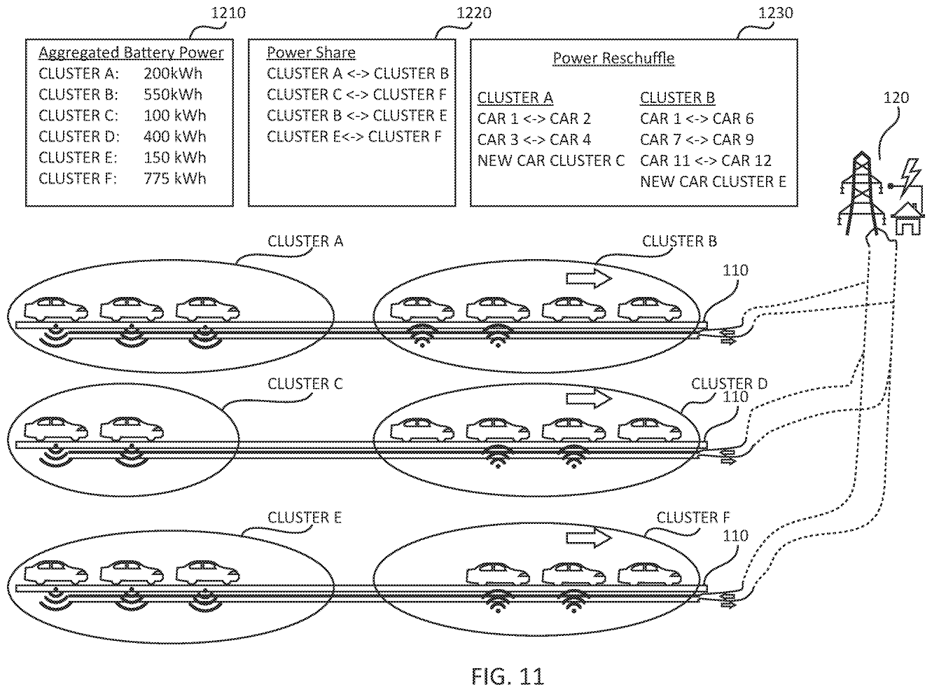

FIG. 11 is a block diagram of an exemplary system where moving vehicles are clustered to extract data therefrom, in accordance with an embodiment of the present invention.

In another exemplary embodiment, the power grid system can use historical learning to identify how much aggregated battery power is needed by a cluster of vehicles to travel to a specified location during a specified period of time. During travel on a common road the cluster of vehicles can share power with each other.

For example, the smart road 110 can be connected to the power grid 120. The first portion of the smart road 110 includes a first cluster of vehicles (Cluster A) and a second cluster of vehicles (Cluster B). The second portion of the smart road 110 includes a third cluster of vehicles (Cluster C) and a fourth cluster of vehicles (Cluster D). The third portion of the smart road 110 includes a fifth cluster of vehicles (Cluster E) and a sixth cluster of vehicles (Cluster F).

A table 1210 can display the aggregated battery power of each cluster of vehicles.

The vehicles in Cluster A have an aggregated battery power of 200 kilowatts per hour.

The vehicles in Cluster B have an aggregated battery power of 550 kilowatts per hour.

The vehicles in Cluster C have an aggregated battery power of 100 kilowatts per hour.

The vehicles in Cluster D have an aggregated battery power of 400 kilowatts per hour.

The vehicles in Cluster E have an aggregated battery power of 150 kilowatts per hour.

The vehicles in Cluster F have an aggregated battery power of 775 kilowatts per hour.

A table 1220 can display power sharing between clusters of vehicles.

Vehicles in Cluster A can share power with vehicles in Cluster B during a specific time of day. Vehicles in Cluster C can share power with vehicles in Cluster F during a specific time of day. Vehicles in Cluster B can share power with vehicles in Cluster E during a specific time of day. Vehicles in Cluster E can share power with vehicles in Cluster F during a specific time of day.

In one instance, a vehicle in Cluster A can request 10 KW of power. A vehicle in Cluster B can respond to the request by accepting the request and transferring all 10 kW of power to vehicle A. In another instance, a vehicle in Cluster A can request 20 kW of power. Two vehicles in Cluster B can respond and each meet the power demands of the vehicle in Cluster A. One vehicle in Cluster B can provide 10 KW (50% of requested power) and another vehicle in Cluster B can provide the remaining 10 KW (50% of requested power). Thus, multiple vehicles in one cluster can provide power to one vehicle in a cooperating cluster of vehicles. Of course, one skilled in the art can contemplate multiple power transfer scenarios where multiple vehicles in one cluster transfer power to multiple vehicles in another cluster.

A table 1230 is presented where power reshuffling can occur within clusters.

For example, in Cluster A, power reshuffling can occur between a first vehicle and a second vehicle. In Cluster A, reshuffling can also occur between a third vehicle and a fourth vehicle. Additionally, a new vehicle can enter Cluster A to enable further power reshuffling. Similarly, in Cluster B various vehicles can power share with each other.

In conclusion, in many situations, traveling vehicles having enough power for the duration or distance of travel may want to participate in a V2G network. In one instance, if any parked or stationary vehicle wants to participate in the V2G network, then the vehicle needs to park at a dedicated location from where two-way power transfer is possible. Therefore, a method and system is presented by which traveling vehicles or vehicles in motion on a smart road are permitted or allowed or enabled to participate in the V2G network and can voluntarily transfer excess power to the power grid.

With further reference to FIG. 11, the exemplary power transfer system uses historical learning to identify how much aggregated battery power is needed by a cluster of vehicles to travel to a specified location for a specified duration of time when additional power sources are to be added to the cluster of vehicles so that required levels of power are available in that cluster of vehicles. During travel, the cluster of vehicles share power with each other and travel together. For example, 20 vehicles may be traveling on a smart road, and based on the aggregated power with the vehicles, each of the vehicles can travel for 60 mins. The exemplary power transfer system adds additional power within 60 mins, so that the cluster of vehicles can continue to run or travel even together even if any vehicle has minimal remaining power so that they can all travel together because of the aggregated battery power.

Based on minimum time needed to add additional battery power to ensure continuous travel of the cluster of vehicles, the exemplary power transfer system considers the required number of vehicles in a cluster with different levels of power storage in the batteries, so that the required level of aggregated battery power is available for travel so that a minimum time required to add additional power is available.

To ensure additional power to any cluster of vehicles, the exemplary power transfer system can reshuffles the vehicles within the cluster of vehicles with different levels of battery power so that the cluster of vehicles have the required power. Further, new vehicles can be added into the cluster, or any other mode of battery can be supplied to the cluster of vehicles, like drones or any surface moving vehicles, which can transfer battery power availability to the cluster of vehicles, so that the cluster of vehicles can obtain the necessary level of aggregated battery power necessary.

The exemplary power transfer system identifies how much power can be transferred by each and every vehicle to the power grid. In this case, different vehicles can transfer different levels of power to the power grid, so that during travel need, the exemplary power transfer system can ensure the required level of aggregated power is available for collaborative travel. Based on the predicted amount of power required for a vehicle to join in any cluster, and the distance required by the vehicle to travel and join in the cluster, the exemplary power transfer system ensures minimum possible power availability with the vehicle.

The exemplary power transfer system considers historical travel patterns of different vehicles, power required, predicted available aggregated power on the smart road in different time frames, etc. The exemplary power transfer system selectively identifies which vehicle is transferring how much power to the power grid, so that during travel need, the vehicle can participate in the cluster of vehicles to obtain the required power.

The exemplary power transfer system tracks power trading by the vehicles, that includes how much power is transferred to the power grid, how much power is received during travel while ensuring minimum aggregating power availability on the clusters of vehicle, and accordingly calculating the cost of travel and income from the power grid. As noted above, a blockchain can be used for tracking power trading between the vehicles within a cluster or within multiple clusters.

Therefore, the exemplary embodiments provide for a smart road that has a mechanism to wirelessly receive power directly from vehicles which are running or traveling or operational on the smart road and transfer the same received power back to the power grid. As a result, vehicles in motion on smart roads can also participate in power sharing by sending excess battery power back to the power grid (without having to park at a predesignated spot to initiate the process). The power transfer process from the vehicles to the power grid can be initiated as the vehicle is moving or traveling or is in motion on a smart road.

In conclusion, regarding FIGS. 1-11, at the bottom side of a vehicle chassis of an autonomous vehicle, a wireless power transfer module or component and a wireless power receiving module or component can be affixed or attached. The smart road has a plurality of wireless power receiving modules or components embedded or integrated therein and connected to a bus. While the autonomous vehicle is traveling on the road, the vehicle is constantly and continuously estimating available battery power. Moreover, the vehicle captures historical travel patterns of the vehicle and identifies how much power is required by the vehicle to reach its final destination. The power receiving module of the vehicle is connected to the power grid and stores the power in the power grid.

Further, the exemplary power transfer system estimates power requirements by any power consumption point and asks the power grid to provide additional power. The power grid identifies if additional power is needed by the power grid from the traveling vehicles. Each and every vehicle identifies the power required by the vehicles and identifies how much power can be transferred to the power grid through the smart road. Based on historical power received from the running or traveling vehicles, the exemplary power transfer system identifies a boundary of any surrounding area or region from where the vehicle can collect or gather or draw power from. The exemplary power transfer system identifies the geo-fencing area or region from where the vehicles can draw power. The exemplary power transfer system publishes or transmits notifications within the identified geo-fencing area, and the traveling vehicles are notified that power collection is requested. Each and every vehicle receives the message and also has the capability to show the rate per unit power transfer to the smart road. The exemplary power transfer system allows the driver of the traveling vehicle to accept or reject (deny) the request of power transfer to the smart road. Therefore, drivers can voluntarily participate in the power transfer program. The drivers are not obligated or mandated or required to do so.

Further, the vehicle can estimate and notify the driver regarding the amount of power that can be transferred to the power grid through the smart road. The exemplary power transfer system identifies which vehicles have participated in power transfer to the power grid through the smart road and identifies which vehicles are receiving power from the smart road while traveling on the smart road. The exemplary power transfer system classifies the vehicles based on which are receiving power from the vehicles and which are transferring power to the grid through the smart road. Based on the identified types of vehicles, the exemplary power transfer system properly arranges the vehicles on the smart road to provide for proper isolation so that interference in induction is avoided or minimized. At a same point of time, different vehicles can receive power and transfer power to the power grid through the smart road while the vehicles are traveling on the smart road (in-motion).

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of methods and devices for transferring power from a traveling or running or operational or moving electric vehicle to the power grid (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A power transfer system comprising:
a smart road having a first power line, a second power line, and a plurality of wireless smart road power receive components;
a plurality of electric vehicles (EVs) traveling on the smart road, each of the EVs having a wireless EV power transfer component and a wireless EV power receive component; and
a power grid electrically connected to the first and second power lines of the smart road to receive power from the plurality of EVs as the plurality of EVs travel on the smart road.

2. The power transfer system of claim 1, wherein consumption points within a geographic area communicate with the power grid to request additional power and the power grid generates a geo-fence surrounding all the consumption points.

3. The power transfer system of claim 2, wherein, after the geo-fence is generated around all the consumption points, the power grid transmits power requirement notifications to EVs of the plurality of EVs within the geo-fence.

4. The power transfer system of claim 3, wherein the EVs of the plurality of EVs within the geo-fence are permitted to respond to the power requirement notifications transmitted from the power grid.

5. The power transfer system of claim 4, wherein the EVs of the plurality of EVs within the geo-fence that opt-in to the power requirement notifications transfer battery power to the smart road, which in turn transfers the battery power to the power grid, which in turn transfers the battery power to the consumption points within the geo-fence.

6. The power transfer system of claim 5, wherein the power grid monitors how much battery power is transferred from each of the EVs of the plurality of EVs within the geo-fence that opt-in to the power requirement notifications and how much power is transferred to each of the EVs of the plurality of EVs within the geo-fence from the smart road to establish whether boundary adjustments to the geo-fence are necessary to provide for adequate power levels.

7. The power transfer system of claim 1, wherein each EV of the plurality of EVs notifies a driver of the respective EV with an amount of battery power available for transfer to the smart road.

8. The power transfer system of claim 1, wherein the power grid keeps track of each EV of the plurality of EVs that has participated in transferring battery power to the power grid via the smart road.

9. The power transfer system of claim 1, wherein the power grid identifies how much aggregated battery power is needed by a cluster of EVs of the plurality of EVs and power sharing between EVs in the cluster of EVs is enabled to meet battery power demands of the cluster of EVs.

10. The power transfer system of claim 1, wherein the plurality of EVs are implemented in a blockchain configuration to capture at least a rate of power transfer, an amount of power transfer, a location of power transfer, and power trading data between the plurality of EVs.

11. A power transfer system comprising:
a smart road having a plurality of wireless smart road power receive components;
a plurality of electric vehicles (EVs) traveling on the smart road, each of the EVs capable of transferring battery power to the wireless smart road power receive components of the smart road; and
a power grid electrically connected to the smart road such that clusters of EVs moving on the smart road voluntarily transfer battery power to the smart road so as to maintain proper isolation between the EVs to avoid induction interference.

12. The power transfer system of claim 11, wherein consumption points within a geographic area communicate with the power grid to request additional power and the power grid generates a geo-fence surrounding all the consumption points.

13. The power transfer system of claim 12, wherein, after the geo-fence is generated around all the consumption points, the power grid transmits power requirement notifications to EVs of the plurality of EVs within the geo-fence.

14. The power transfer system of claim 13, wherein the EVs of the plurality of EVs within the geo-fence are permitted to respond to the power requirement notifications transmitted from the power grid.

15. The power transfer system of claim 14, wherein the EVs of the plurality of EVs within the geo-fence that opt-in to the power requirement notifications transfer battery power to the smart road, which in turn transfers the battery power to the power grid, which in turn transfers the battery power to the consumption points within the geo-fence.

16. The power transfer system of claim 15, wherein the power grid monitors how much battery power is transferred from each of the EVs of the plurality of EVs within the geo-fence that opt-in to the power requirement notifications and how much power is transferred to each of the EVs of the plurality of EVs within the geo-fence from the smart road to establish whether boundary adjustments to the geo-fence are necessary to provide for adequate power levels.

17. The power transfer system of claim 11, wherein the power grid keeps track of each EV of the plurality of EVs that has participated in transferring battery power to the power grid via the smart road.

18. The power transfer system of claim 11, wherein the power grid identifies how much aggregated battery power is needed by the clusters of EVs and power sharing between EVs in the clusters of EVs is enabled to meet battery power demands of the clusters of EVs.

19. The power transfer system of claim 11, wherein the plurality of EVs are implemented in a blockchain configuration to capture at least a rate of power transfer, an amount of power transfer, a location of power transfer, and power trading data between the plurality of EVs.

20. A method for transferring power comprising:
incorporating a first power line, a second power line, and a plurality of wireless smart road power receive components into a smart road;
allowing a plurality of electric vehicles (EVs) to travel on the smart road, each of the EVs having a wireless EV power transfer component and a wireless EV power receive component; and
electrically connecting a power grid to the first and second power lines of the smart road to receive power from the plurality of EVs as the plurality of EVs travel on the smart road.
